(19) United States
(12) Patent Application Publication
(10) Pub. No.: US 2009/0103601 A1
(43) Pub. Date: Apr. 23, 2009

(54) Methods for Soft Bit Companding for Time De-interleaving of Digital Signals

(75) Inventors: Jianxuan Du, San Jose, CA (US); Yue Chen, Fremont, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/253,919

(22) Filed: Oct. 17, 2008

Related U.S. Application Data
(60) Provisional application No. 60/980,742, filed on Oct. 17, 2007.

(51) Int. Cl. H04B 1/66

(52) U.S. Cl. 375/240

(57) ABSTRACT

This invention provides methods for reducing the bit width of soft information, while maintaining a large dynamic range by applying compression and expansion. In particular, this invention provides methods for time de-interleaving of soft information, comprising the steps of: quantizing the soft information into a first soft information having a first pre-defined number of bits; compressing the first soft information into a second soft information having a second pre-defined number of bits; time de-interleaving the second soft information; and decompressing the time de-interleaved second soft information.

### CROSS REFERENCE

This application claims priority from a provisional patent application entitled “Soft Bit Companding for Time De-interleaving” filed on Oct. 17, 2007 and having an Application No. 60/980,742. Said application is incorporated herein by reference.

### FIELD OF INVENTION

This invention relates to methods for time de-interleaving of digital signals, and, in particular, to methods for soft bit companding of bits for use in time de-interleaving of received orthogonal frequency division multiplexing (“OFDM”) modulated signals.

### BACKGROUND

With the advancement of mobile communication technologies, the reception of TV signals is undergoing a major revolution from analog to digital. T-DMB and ISDB-T systems, for example, have been developed to enable portable and mobile reception of digital TV signals in a variety of environments. To counter the effect of fast channel fading introduced by the movement of a receiver, time interleaving is employed so that adjacent bits in a codeword are distributed across a number of symbols.

Time interleaving is used in communication technologies to protect a transmission against burst errors. These errors overwrite many adjacent bits in a carrier, such that typical error correction schemes which expect errors to be uniformly distributed over various carriers and at various times can be overwhelmed. Interleaving is used to alleviate such problems. A drawback of time interleaving is that a large number of soft bits from the soft demodulator must be saved in memory before all the bits are available for channel decoding.

In particular, the DAB and T-DMB systems have 3456 de-interleaving units. FIG. 1 illustrates such a de-interleaving unit, where 16 input bits, b0 through b15, are input to the time de-interleaver. The buffer for each bit holds each input bit for a defined amount of time, wherein that defined amount of time corresponds to the interleaving scheme for those bits during the transmission of those bits. For instance, b0 is stored for 15 units of time, and then is output. Additionally, b1 is stored for 7 units of time before being output, and so forth.

To reduce the amount of memory used for time de-interleaving, the number of bits used to represent a soft decision for each demodulated bit can be reduced. However, the reduction in bit width decreases the dynamic range that can be represented and thus degrades the performance of the channel decoder. The reason for the performance degradation is due to the reduction in magnitude of high fidelity soft bits, since large values are saturated by the linear soft bit demodulator.

Therefore, it is desirable to provide methods for shrinking the bit width of soft bits, while minimizing the performance degradation by maintaining a large dynamic range.

### SUMMARY OF INVENTION

An object of this invention is to provide methods for mapping derived soft bits from a demodulator to bits of a smaller bit-width for use as input to a time de-interleaver.

Another object of this invention is to provide methods for a compandor with enhanced dynamic range, where the overall compandor response guarantees exact reconstruction at small input values, while introducing small reconstruction errors at large input values.

Yet another object of this invention is to provide methods for non-linear soft-bit companding, i.e. compression and expansion, which can reduce the memory requirement for time de-interleaving by one-fifth.

Briefly, this invention provides methods for time de-interleaving of soft information, comprising the steps of: quantizing the soft information into a first soft information having a first pre-defined number of bits; compressing the first soft information into a second soft information having a second pre-defined number of bits; time de-interleaving the second soft information; and decompressing the time de-interleaved second soft information.

An advantage of this invention is that methods for mapping derived soft bits from a demodulator to bits of a smaller bit width for use as input to a time de-interleaver are provided.

Another advantage of this invention is that methods for a compandor with enhanced dynamic range are provided, where the overall compandor response guarantees exact reconstruction at small input values, while introducing small reconstruction errors at large input values.

Yet another advantage of this invention is that methods for non-linear soft-bit companding, i.e. compression and expansion, which reduces the memory requirement for time de-interleaving by one-fifth are provided.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates a de-interleaving unit for use in DAB and T-DMB systems.

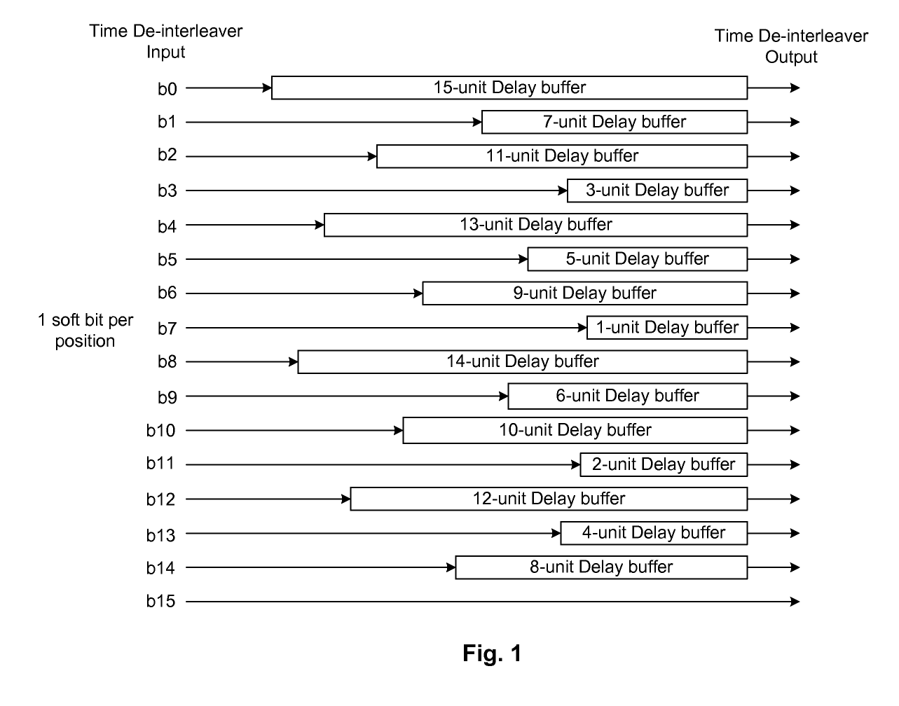

FIG. 2 illustrates a process flow for soft bit companding for use in time de-interleaving and decoding.

FIG. 3 illustrates a mapping curve for a MapCompandor.

FIG. 4 illustrates a mapping curve for the MapInvCompandor.

FIG. 5 illustrates the overall compandor response curve, including compression and decompression.

### DETAILED DESCRIPTION OF THE PREFERRED EMBODIMENTS

The following description of the present invention will be explained with reference to the telecommunications field. In no way shall the present invention be limited to the telecommunications field. In fact, the present invention can be applied to all fields which use time de-interleaving.

To reduce memory usage for time de-interleaving and to facilitate hardware implementation without performance degradation, soft bit companding is used to extend the dynamic range of 4-bit soft information used by time de-interleavers.

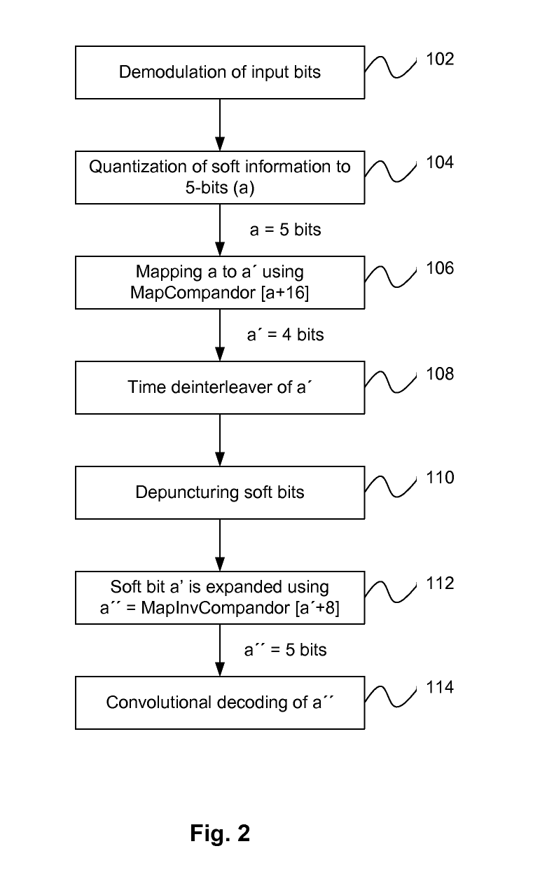

FIG. 2 is a process flow illustrating a method for time de-interleaving using soft bit companding. Soft information derived from demodulation 102, or derived from any other source, can be quantized 104 at the output of the demodulator into a data string with a width of 5 bits, a, where that data string may range in value from −16 to 15.

The quantized 5-bit soft information, a, is then mapped to a value with a width of 4 bits, a′, 106. This mapping can be defined as:

a′=MapCompandor [a+16] (1)

where MapCompandor [x]={−8, −7, −7, −7, −7, −7, −6, −6, −6, −6, −5, −5, −4, −3, −2, −1, 0, 1, 2, 3, 4, 5, 5, 6, 6, 6, 6, 7, 7, 7, 7, 7} for x=0 to 31;

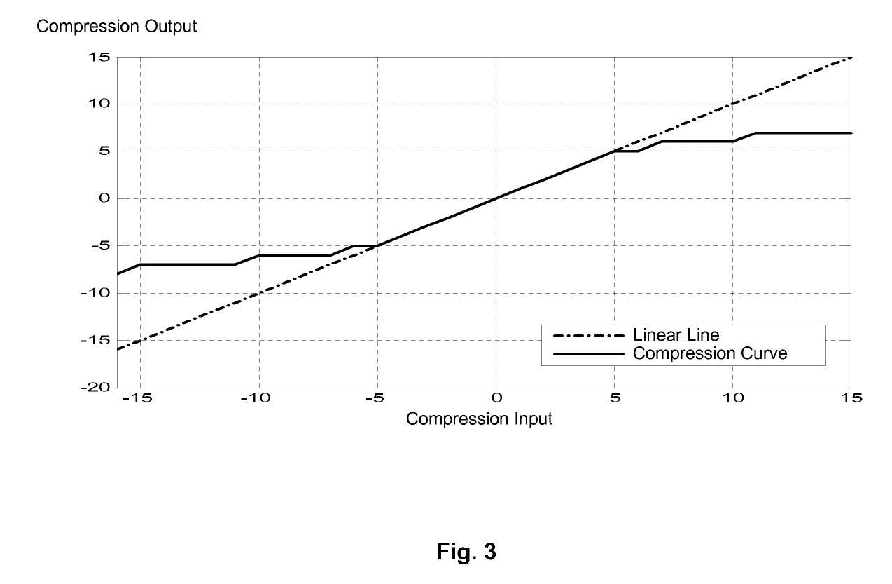

FIG. 3 illustrates a mapping curve for the MapCompandor. The compression curve reflects the compression output a′ as a function of the compression input a using Equation (1). This mapping step can also be referred to as a compressing step, wherein in that step a 5-bit value, a, is compressed into a 4-bit value, a′, via a defined mapping. For comparison, the linear line represents the output for an input value that has not been compressed; therefore the output exactly matches the input for this linear line.

Referring back to the process flow in FIG. 2, the 4-bit soft information, a′, can be inputted to a time de-interleaver 108.

Before decoding, the output of the time de-interleaver is depunctured 110. Note, depuncturing can be an optional step, or can be included in the step of convolutional decoding 114. The 4-bit depunctured output, a′, can be expanded 112, or in other words decompressed back to a 5-bit soft information a″,

a″=MapInvCompandor [a′+8] (2)

where MapInvCompandor [y]={−16, −13, −8, −5, −4, −3, −2, −1, 0, 1, 2, 3, 4, 5, 8, 13} for y=0 to 15.

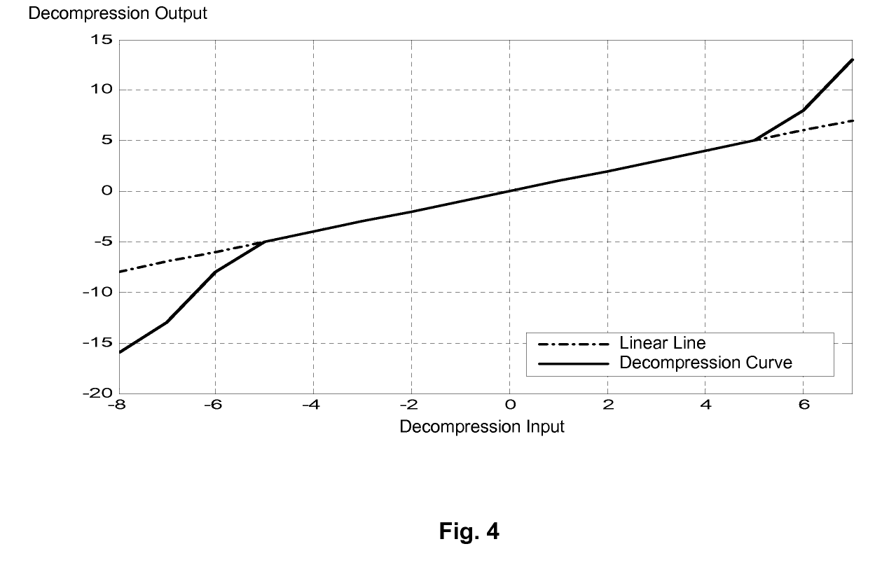

FIG. 4 illustrates a mapping curve for the MapInvCompandor. The compression curve reflects the decompression output a″ as a function of the decompression input a′ using Equation (2). This mapping step can also be referred to as a decompressing step, wherein in that step a 4-bit value, a′, is decompressed into a 5-bit value, a″, via a defined mapping. For comparison, the linear line represents the output for a decompressed input that has not been expanded; thus the decompressed output exactly matches the decompressed input.

Referring back to the process flow in FIG. 2, the 5-bit soft information a″ can finally be used as input for a convolutional decoder 114.

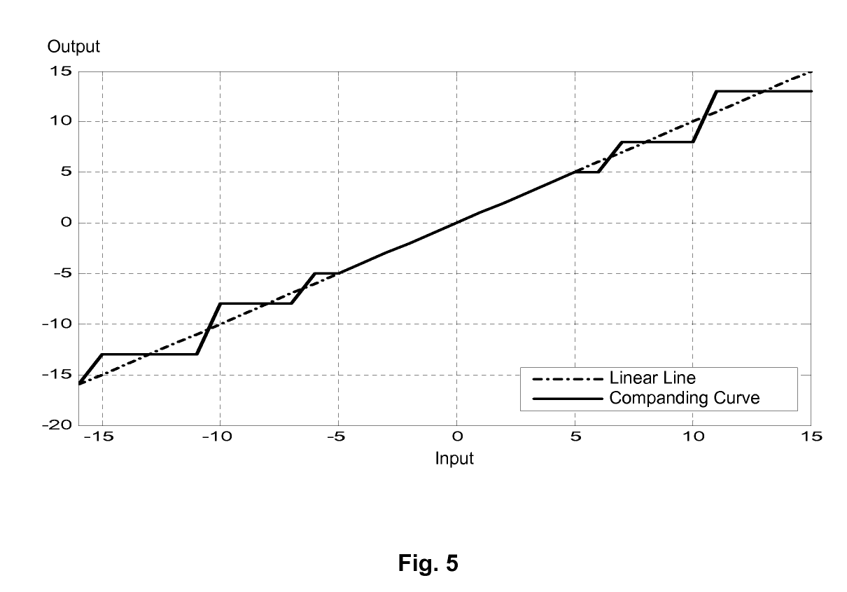

FIG. 5 illustrates the overall compandor response curve, including compression and decompression. Although the compandor introduces additional distortion, the performance of soft-bit companding (e.g the companding curve) is close to that of a time de-interleaver using linear quantization of a larger bit-width (e.g. the linear line) since the compandor keeps the details of small values while introducing some quantization errors at large values.

Appendix I is a precomputed table of values illustrating a′ and a″ for a given soft information value, a, where the values of a range from −16 to 15 inclusively and where the precomputed a′ and a″ are in the same row. For instance, a 5-bit soft information of value −7 can be compressed using Equation (1) to a 4-bit value of −6 for use in a de-interleaver. The 4-bit output of that de-interleaver can then be decompressed using Equation (2) to get back a 5-bit value of −8. This can also be found in Appendix I by looking up the row where a is equal to −7. In that row, a′ is equal to −6, and a″ is equal to −8.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

APPENDIX I

| 5-bits soft bit (a) | 4-bits (a′) | 5-bits (a″) |
|---|---|---|
| −16 | −8 | −16 |
| −15 | −7 | −13 |
| −14 | −7 | −13 |
| −13 | −7 | −13 |
| −12 | −7 | −13 |
| −11 | −7 | −13 |
| −10 | −6 | −8 |
| −9 | −6 | −8 |
| −8 | −6 | −8 |
| −7 | −6 | −8 |
| −6 | −5 | −5 |
| −5 | −5 | −5 |
| −4 | −4 | −4 |
| −3 | −3 | −3 |
| −2 | −2 | −2 |
| −1 | −1 | −1 |
| 0 | 0 | 0 |
| 1 | 1 | 1 |
| 2 | 2 | 2 |
| 3 | 3 | 3 |
| 4 | 4 | 4 |
| 5 | 5 | 5 |
| 6 | 5 | 5 |
| 7 | 6 | 8 |
| 8 | 6 | 8 |
| 9 | 6 | 8 |
| 10 | 6 | 8 |
| 11 | 7 | 13 |
| 12 | 7 | 13 |
| 13 | 7 | 13 |
| 14 | 7 | 13 |
| 15 | 7 | 13 |

1. A method for time de-interleaving of soft information, comprising the steps of:
quantizing the soft information into a first soft information having a first pre-defined number of bits;
compressing the first soft information into a second soft information having a second pre-defined number of bits;
time de-interleaving the second soft information; and
decompressing the time de-interleaved second soft information.

2. The method of claim 1 wherein the first pre-defined number of bits is 5.

3. The method of claim 1 wherein the second pre-defined number of bits is 4.

4. The method of claim 2 wherein the second pre-defined number of bits is 4.

5. The method of claim 1 wherein the first pre-defined number of bits is greater than the second pre-defined number of bits.

6. The method of claim 1 wherein the compressing is non-linear.

7. The method of claim 1 wherein the decompressing is non-linear.

8. The method of claim 1 wherein the compressing and decompressing steps provide an exact reconstruction for soft information at small values.

9. The method of claim 1 wherein the compressing and decompressing steps provide larger reconstruction errors for soft information at large values.

10. The method of claim 8 wherein the compressing and decompressing steps provide larger reconstruction errors for soft information at large values.

11. The method of claim 1 wherein the compressing and decompressing steps provide that the decompressed second soft information having the same dynamic range as the first soft information.

12. The method of claim 1 wherein the compressing step utilizes a function MapCompandor, wherein MapCompandor[−16 . . . 15]={−8, −7, −7, −7, −7, −7, −6, −6, −6, −6, −5, −5, −4, −3, −2, −1, 0, 1, 2, 3, 4, 5, 5, 6, 6, 6, 6, 7, 7, 7, 7, 7}.

13. The method of claim 1 wherein the decompressing step utilizes a function MapInvCompandor, wherein MapInvCompandor[−8 . . . 7]={−16, −13, −8, −5, −4, −3, −2, −1, 0, 1, 2, 3, 4, 5, 8, 13}.

14. A method for time de-interleaving of soft information, comprising the steps of:
quantizing the soft information into a first soft information having a first pre-defined number of bits;
compressing the first soft information into a second soft information having a second pre-defined number of bits, wherein the first pre-defined number of bits is greater than the second pre-defined number of bits and the compressing is non-linear;
time de-interleaving the second soft information; and
decompressing the time de-interleaved second soft information, wherein the decompressing is non-linear.

15. The method of claim 14 wherein the first pre-defined number of bits is 5.

16. The method of claim 15 wherein the second pre-defined number of bits is 4.

17. The method of claim 16 wherein the compressing and decompressing steps provide an exact reconstruction for soft information at small values and the compressing and decompressing steps provide larger reconstruction errors for soft information at large values.

18. The method of claim 14 wherein the compressing and decompressing steps provide that the decompressed second soft information having the same dynamic range as the first soft information.

19. The method of claim 14 wherein the compressing step utilizes a function MapCompandor, wherein MapCompandor[−16 . . . 15]={−8, −7, −7, −7, −7, −7, −6, −6, −6, −6, −5, −5, −4, −3, −2, −1, 0, 1, 2, 3, 4, 5, 5, 6, 6, 6, 6, 7, 7, 7, 7, 7}, and wherein the decompressing step utilizes a function MapInvCompandor, wherein MapInvCompandor[−8 . . . 7]={−16, −13, −8, −5, −4, −3, −2, −1, 0, 1, 2, 3, 4, 5, 8, 13}.

20. A method for time de-interleaving of soft information, wherein there is exact reconstruction for soft information at small values and there are larger reconstruction errors for soft information at large values, comprising the steps of:
quantizing soft information into a first soft information having 5 bits;
compressing the first soft information into a second soft information by utilizing a function MapCompandor, wherein said second soft information has 4 bits, wherein MapCompandor[−16 . . . 15]={−8, −7, −7, −7, −7, −7, −6, −6, −6, −6, −5, −5, −4, −3, −2, −1, 0, 1, 2, 3, 4, 5, 5, 6, 6, 6, 6, 7, 7, 7, 7, 7}, and wherein the compressing is non-linear;
time de-interleaving the second soft information; and
decompressing the time de-interleaved second soft information by utilizing a function MapInvCompandor, wherein MapInvCompandor[−8 . . . 7]={−16, −13, −8, −5, −4, −3, −2, −1, 0, 1, 2, 3, 4, 5, 8, 13} and wherein the decompressing is non-linear;
wherein the decompressed second soft information has the same dynamic range as the first soft information.
